(19) United States
(12) Patent Application Publication
(10) Pub. No.: US 2019/0266802 A1
(43) Pub. Date: Aug. 29, 2019

(54) Display of Visual Data with a Virtual Reality Headset

(71) Applicant: Nokia Technologies Oy, Espoo (FI)

(72) Inventors: Toni JARVENPAA, Akaa (FI); Peter ESKOLIN, Pirkkala (FI); Marja SALMIMAA, Tampere (FI); Petri PIIPPO, Lempaala (FI)

(21) Appl. No.: 16/340,801

(22) PCT Filed: Sep. 27, 2017
(86) PCT No.: PCT/FI2017/050683

§ 371 Date: Apr. 10, 2019

(30) Foreign Application Priority Data
Oct. 14, 2016 (GB) 1617493.0

(51) Int. Cl. G06T 19/00; G02B 27/01; G06F 3/0481; H04N 5/232; G06F 16/78; G06T 7/20; H04S 7/00

(52) U.S. Cl. CPC G06T 19/006; G02B 27/0172; G06F 3/04815; G02B 2027/0187; G06F 16/78; G06T 7/20; H04S 7/304; H04N 5/23238

(57) ABSTRACT

This specification describes a method including determining a resolution of visual source content, determining a resolution and a field of view of a display of a virtual reality headset, determining, based at least in part on the resolution of the visual source content; the resolution of the display; and the field of view of the display: a field of view for display of visual data corresponding to the visual source content in the virtual reality space, and a projection shape for display of the visual data corresponding to the visual source content in the virtual reality space, the projection shape including one of a flat projection, a horizontally curved projection, a vertically curved projection, a spherical projection, and a combination thereof.

### FIELD

This specification generally relates to handling the field of view and projection shape of visual data for display using a virtual reality headset.

### BACKGROUND

Virtual reality (VR) headsets can be used to display non-VR content. Non-VR content includes standard movies, videos, and photos such as those captured with a smartphone, and 2D or 3D movies. Such non-VR content is usually displayed on a fixed, flat screen, such as a television, or on a cinema screen. On a VR headset, the non-VR video content may be displayed in a simulated movie or home theatre, with the video fitted inside a fixed, flat frame, which may be referred to as a virtual screen.

### SUMMARY

According to a first aspect, the specification describes a method comprising: determining a resolution of visual source content; determining a resolution and a field of view of a display of a virtual reality headset; determining, based at least in part on the resolution of the visual source content, the resolution of the display, and the field of view of the display: a field of view for display of visual data corresponding to the visual source content in the virtual reality space; and a projection shape for display of the visual data corresponding to the visual source content in the virtual reality space, the projection shape comprising one of a flat projection, a horizontally curved projection, a vertically curved projection, a spherical projection, and a combination thereof.

The field of view and/or projection shape for display of the visual data may be determined based at least in part on a compression level of the visual source content.

The field of view and/or projection shape for display of the visual data may be determined based on a predetermined threshold for an accommodation convergence mismatch of the visual data.

The method may further comprise adjusting at least one spatial audio parameter of a spatial audio scene associated with the visual data in accordance with the field of view and/or the projection shape for display of the visual data. The spatial audio parameter may comprise at least one location of at least one audio source, a width or a height of the spatial audio scene, or a combination thereof.

The visual source content may comprise at least one two-dimensional video, at least one two-dimensional image, or at least part of a 360 degree panoramic video.

At least one of the field of view and the projection shape for display of the visual data may be dynamically adjustable based on metadata associated with the visual source content, an analysis of the visual data, and/or an input from a user. The field of view and/or the projection shape for display of the visual data may be dynamically adjustable based at least in part on visual source content data comprising at least one of motion tracking data, focal length, and zoom level.

The method may further comprise rendering the visual data for display on a virtual reality headset.

According to a second aspect, the specification describes a computer program comprising machine readable instructions that when executed by computing apparatus causes it to perform any method as described with reference to the first aspect.

According to a third aspect, the specification describes an apparatus configured to perform any method as described with respect to the first aspect.

According to a fourth aspect, the specification describes an apparatus comprising: at least one processor; and
at least one memory including computer program code, which when executed by the at least one processor, causes the apparatus to perform a method comprising:
determining a resolution of visual source content;
determining a resolution and a field of view of a display of a virtual reality headset;
determining, based at least in part on the resolution of the visual source content, the resolution of the display, and the field of view of the display: a field of view for display of visual data corresponding to the visual source content in the virtual reality space; and a projection shape for display of the visual data corresponding to the visual source content in the virtual reality space, the projection shape comprising one of a flat projection, a horizontally curved projection, a vertically curved projection, a spherical projection, and a combination thereof.

The field of view and/or projection shape for display of the visual data may be determined based at least in part on a compression level of the visual source content.

The field of view and/or projection shape for display of the visual data may be determined based on a predetermined threshold for an accommodation convergence mismatch of the visual data.

The computer program code, when executed by the at least one processor, may cause the apparatus to perform: adjusting at least one spatial audio parameter of a spatial audio scene associated with the visual data in accordance with the field of view and/or the projection shape for display of the visual data. The spatial audio parameter may comprise at least one location of at least one audio source, a width or a height of the spatial audio scene, or a combination thereof.

The visual source content may comprise at least one two-dimensional video, at least one two-dimensional image, or at least part of a 360 degree panoramic video.

At least one of the field of view and the projection shape for display of the visual data may be dynamically adjustable based on metadata associated with the visual source content, an analysis of the visual data, and/or an input from a user. The field of view and/or the projection shape for display of the visual data may be dynamically adjustable based at least in part on visual source content data comprising at least one of motion tracking data, focal length, and zoom level.

The computer program code, when executed by the at least one processor, may cause the apparatus to perform: rendering the visual data for display on a virtual reality headset.

According to a fifth aspect, the specification describes a computer-readable medium having computer-readable code stored thereon, the computer-readable code, when executed by at least one processor, cause performance of at least: determining a resolution of visual source content; determining a resolution and a field of view of a display of a virtual reality headset; determining, based at least in part on the resolution of the visual source content, the resolution of the display, and the field of view of the display: a field of view for display of visual data corresponding to the visual source content in the virtual reality space; and a projection shape for display of the visual data corresponding to the visual source content in the virtual reality space, the projection shape comprising one of a flat projection, a horizontally curved projection, a vertically curved projection, a spherical projection, and a combination thereof.

According to a sixth aspect, the specification describes an apparatus comprising means for: determining a resolution of visual source content; determining a resolution and a field of view of a display of a virtual reality headset; determining, based at least in part on the resolution of the visual source content, the resolution of the display, and the field of view of the display: a field of view for display of visual data corresponding to the visual source content in the virtual reality space; and a projection shape for display of the visual data corresponding to the visual source content in the virtual reality space, the projection shape comprising one of a flat projection, a horizontally curved projection, a vertically curved projection, a spherical projection, and a combination thereof.

### BRIEF DESCRIPTION OF THE FIGURES

For a more complete understanding of the methods, apparatuses and computer-readable instructions described herein, reference is now made to the following descriptions taken in connection with the accompanying drawings in which:

FIG. 1 is a schematic illustration of a VR display system, according to embodiments of this specification;

FIG. 2 illustrates an example of an equirectangular 360 map including a view through a VR headset which receives visual data from the VR media player, as provided by embodiments of this specification;

FIG. 3 illustrates an example of a view through a VR headset, where the content field of view is increased compared to FIG. 2, as provided by embodiments of this specification;

FIG. 4 illustrates an example of a view through a VR headset, where the visual data is projected onto a spherical virtual screen, as provided by embodiments of this specification;

FIG. 5 illustrates an example of mapping content from a flat virtual screen to a spherical virtual screen, according to embodiments of this specification;

FIG. 6 is a schematic illustration of a spatial audio arrangement linked with the spatial projection of the visual data, as provided by embodiments of this specification;

FIG. 7 is a flow chart illustrating an example of operations which may be performed by the VR media player, according to embodiments of this invention;

FIG. 8 is a schematic illustration of an example configuration of the VR media player, according to embodiments of this specification; and

FIG. 9 is a computer-readable memory medium upon which computer readable code may be stored, according to embodiments of this specification.

### DETAILED DESCRIPTION

In the description and drawings, like reference numerals may refer to like elements throughout.

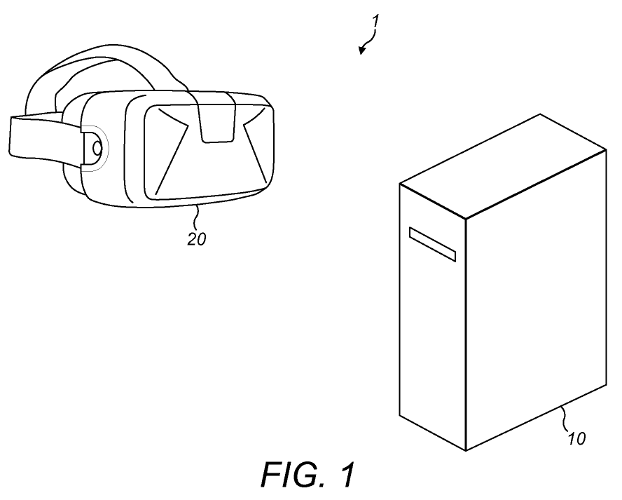

FIG. 1 is a schematic illustration of a virtual reality (VR) display system 1. The VR system 1 includes a VR headset 20, for displaying visual data in a virtual reality space, and a VR media player 10 for rendering visual data on the VR headset 20.

In the context of this specification, a virtual space is any computer generated version of a space, for example a captured real world space, in which a user can be immersed. The VR headset 20 may be of any suitable type. The VR headset 20 may be configured to provide VR video and audio content to a user. As such, the user may be immersed in virtual space.

The VR headset 20 receives visual content from a VR media player 10. The VR media player 10 may be part of a separate device which is connected to the VR headset 20 by a wired or wireless connection. For example, the VR media player 10 may include a games console, or a PC configured to communicate visual data to the VR headset 20.

Alternatively, the VR media player 10 may form part of the display for the VR headset 20.

Here, the media player 10 may comprise a mobile phone, smartphone or tablet computer configured to play content through its display. For example, the device may be a touchscreen device having a large display over a major surface of the device, through which video content can be displayed. The device may be inserted into a holder of a VR headset 20, such as the Samsung headset known as the Gear VR and such like. With these headsets, a smart phone or tablet computer may display visual data which is provided to a user's eyes via respective lenses in the VR headset 20. The VR display system 1 may also include hardware configured to convert the device to operate as part of VR display system 1. Alternatively, VR media player 10 may be integrated into the VR display device 20. VR media player 10 may be implemented in software. In some embodiments a device comprising VR media player software is referred to as the VR media player 10.

The VR display system 1 may include means for determining an orientation of the user's head. Such means may comprise part of the VR media player 10. Alternatively, the means may comprise part of the VR headset 20. The VR display system 1 may be configured to display visual data to the user based on the orientation of the user's head. A detected change in orientation may result in a corresponding change in the visual data to reflect an orientation transformation of the user with reference to the virtual space into which the visual data is projected. This allows VR content to be consumed with the user experiencing a 3D VR environment.

The VR headset 20 may display non-VR video content captured with two-dimensional video or image devices, such as a smartphone or a camcorder, for example. Such non-VR content may include a framed video or a still image. The non-VR source content may be 2D, stereoscopic or 3D. The non-VR source content includes visual source content, and may optionally include audio source content. Such audio source content may be spatial audio source content. Spatial audio may refer to directional rendering of audio in the virtual space such that a detected change in the orientation of the user's head may result in a corresponding change in the spatial audio rendering to reflect an orientation transformation of the user with reference to the virtual space in which the spatial audio data is rendered. The display of the VR headset is described in more detail below.

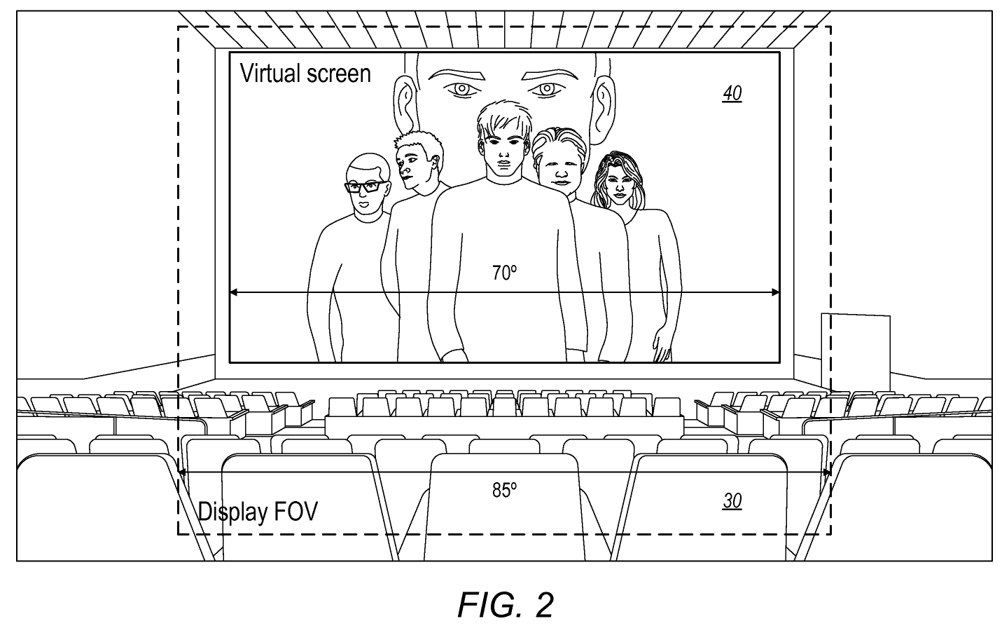

FIG. 2 is a schematic illustration of an equirectangular 360 map including a view through the VR headset 20.

The angular extent of the virtual environment observable through the VR headset 20 is called the visual field of view (FOV) of the headset 20. The actual FOV observed by a user depends on the interpupillary distance and on the distance between the lenses of the headset and the user's eyes, but the FOV can be considered to be approximately the same for all users of a given headset when the headset is being worn by the user.

The visual source content has a FOV associated with it, which may differ from the FOV of the VR headset 20. The FOV of the source content depends on the FOV of the camera which recorded the content. The FOV of the camera may depend on camera settings, for example a zoom level. However, it will be understood that any processing of the content after the content is recorded, such as cropping the content, may affect the FOV of the content. For example, if the content is cropped, then the FOV of the content is reduced.

The VR headset 20 may display non-VR content captured with ordinary cameras in a simulated movie or home theatre, with the visual data corresponding to the visual source content fitted inside a fixed, flat frame 40. Such a fixed, flat frame may be referred to as a virtual screen. Edges of the virtual screen may be fixed to the world coordinates and the surroundings of the screen may include other fixed items such as chairs. This likely results in little induced motion sickness. However, displaying the non-VR content in a fixed, flat frame may result in many of the picture details being lost. For example when using the Samsung Gear VR model SM-R322 with a Samsung Galaxy S6 phone, the Oculus Video application in Cinema mode displays standard 1080p (1920×1080) video content in an approximately 70 degree wide frame, using about 800×480 display pixels for the video. In such an example, the resolution of the displayed visual data is less than the native resolution of the visual source content.

The VR media player 10 is configured to determine the native resolution of the non-VR visual source content. The native resolution of the content in the context of this specification refers to the number of content pixels of the visual source content. Additionally, the VR media player 10 is configured to determine the FOV and resolution of the VR headset 20. Based at least in part on the determined native resolution of the content and the FOV and resolution of the VR headset 20, the VR media player 10 is configured to determine a FOV and a projection shape for display of the visual data in the virtual space 30. In this way, the presentation of standard videos viewed using the VR headset 20 can be improved.

For example, the virtual reality media player 10 may be configured to ‘zoom in’ and make the virtual screen frame wider and/or higher. This increases the horizontal and/or vertical FOV of the visual data displayed through the VR headset 20. This corresponds to increasing the magnification of the visual data being displayed, and increasing the horizontal and/or vertical angular extent of the visual data observed through the VR headset 20. In this way, the resolution of the visual data being displayed may be closer to, or the same as, the native resolution of the display.

For example, for a VR display having an 85 degree horizontal FOV and a display resolution of 1280×1440, natively presented content with 1080p resolution corresponds to an image having an approximate horizontal angular extent of 128 degrees and exceeding the display FOV. Natively presented content with 720p resolution on the same 85 degree FOV display corresponds to an image having an approximate horizontal angular extent of 85 degrees.

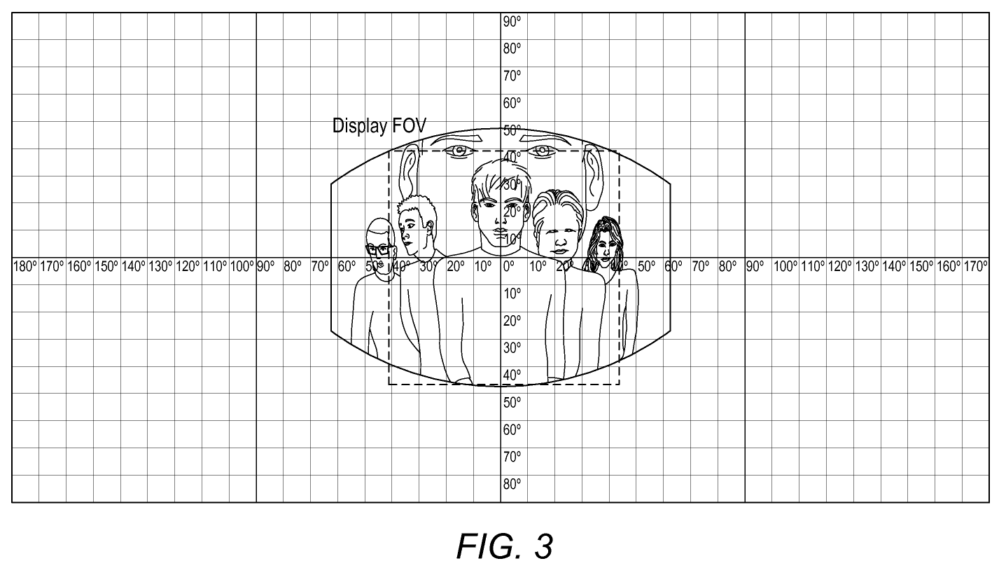

FIG. 3 illustrates an embodiment in which the FOV of the displayed visual data has been increased beyond the fixed, flat virtual screen 40. Due to the magnification of the visual data, the resulting picture is larger and more detailed, as a larger number of content pixels are displayed. Alternatively to increasing the FOV of the content being displayed on the VR headset 20, the VR media player 10 may be configured to crop low resolution 360 degree panoramic VR content or low resolution wide angle content and fit into a limited frame size. In this way, the observed quality of the content may be improved. For example, 360 degree panoramic video content may be cropped to the central view. The amount of cropping may be selected based on the content.

The FOV for display of the visual data may be different from the FOV of the VR headset 20. For example, the FOV for display of the visual data may be greater than the FOV of the VR headset 20. In such a case, all of the visual data may not be observable through the VR headset 20 simultaneously. The user can therefore change the orientation of their head, which changes the portion of the visual data which is displayed through the VR headset. This results in the content being displayed as pannable visual data. For example, the VR media player may determine that a 360 degree panoramic video should have a FOV of 360 degrees for display through the VR headset 20. Therefore, a limited portion of the visual data corresponding to the source 360 degree panoramic video is observable through the VR headset. The user is required to rotate their head throughout the whole 360 degree range in order to observe the whole of the 360 degree panorama. However, it should be understood that the FOV for display of the visual data may be a different angular range to the FOV of the visual source content. In some embodiments, the FOV for display of the visual data may be smaller than the FOV of the VR headset 20. In some embodiments the FOV for display of the visual data may be dynamic. In some embodiments, the FOV for display of the visual data may be smaller than the FOV of the VR headset 20 at a first time instant. At a second time instant the FOV for display of the visual data may be greater than or equal to the FOV of the VR headset 20. In the above examples, ‘greater’ may refer to higher or wider, or a combination thereof.

The user may be able to change their orientation relative to a virtual screen showing visual data which has a FOV of less than 360 degrees. Therefore, the user may be able to rotate in a direction facing away from the virtual screen such that visual data corresponding to the visual source content is not visible through the display of the VR headset 20. Alternatively, the VR media player 10 may be configured to move the rotational position of the virtual screen together with the change in orientation of the user. For example, if the user rotates their head such that the edge of the FOV of the VR headset display reaches the edge of the FOV of the virtual screen, the VR media player 10 may be configured to move the virtual screen to prevent the virtual screen leaving the FOV of the VR headset 20. In this way, a portion of the visual data on the virtual screen is visible to the user from the VR headset 20 display regardless of the orientation of the user.

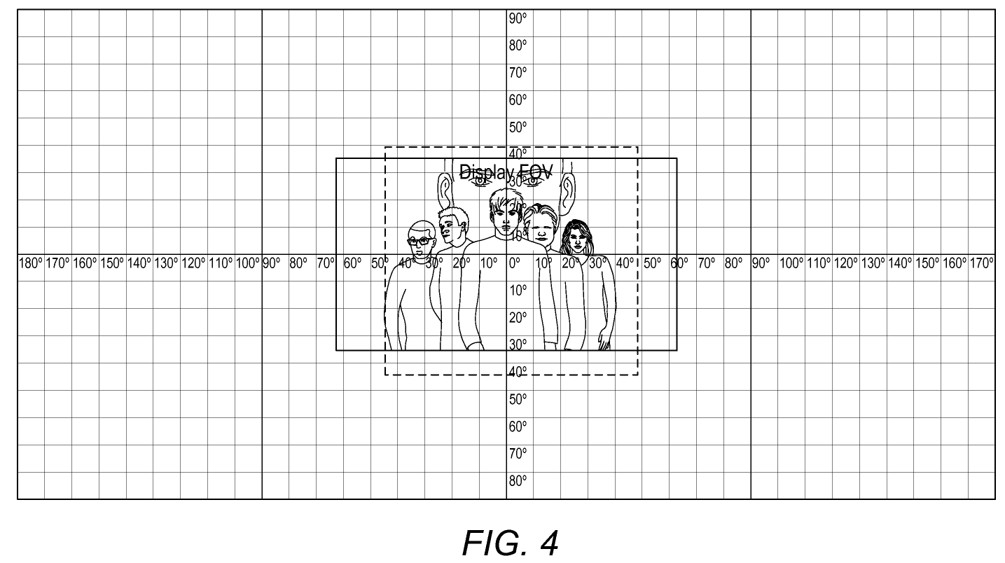

FIG. 4 illustrates an embodiment in which the visual data is projected into the virtual space 30 in a spherical projection. For example, the video may be projected into a surface curved in one dimension (one of horizontally or vertically), but not in a second dimension. Alternatively, as is the case in the example of FIG. 4, the video may be projected into a spherical surface which is curved in both horizontal and vertical dimensions. The visual data may be projected into a shape comprising any of a flat projection, a horizontally curved projection, a vertically curved projection, a spherical projection, or a combination thereof. Projecting the video in the virtual space to be curved around the viewer may help to reduce undesirable effects when increasing the magnification. Such undesirable effects may include disproportionate magnification in the central region of the video, which can make the video look unnatural and centrally pixelated, as shown in FIG. 3.

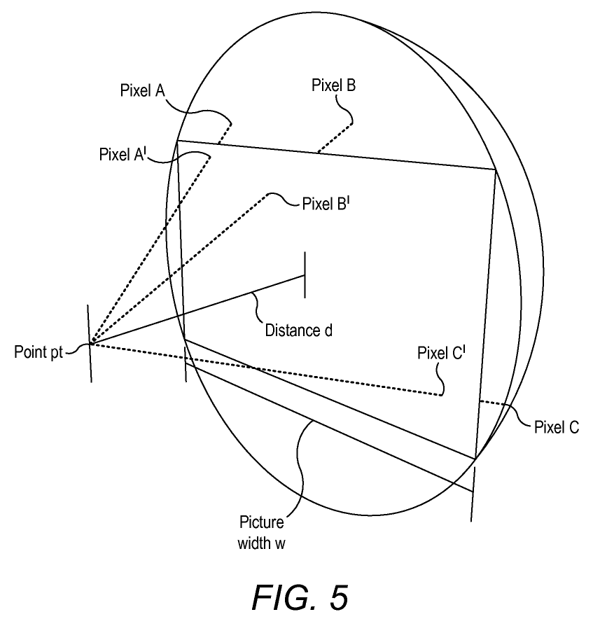

FIG. 5 illustrates how the visual data may be transformed from a flat projection to a spherical projection. Pixels A′, B′, C′ and D′ are pixels of the captured visual data. A virtual transformation is applied to the content pixels to the new pixel positions of pixels A, B, C and D, which results in the projection of the video in the virtual space 30 being onto a spherical surface. The calculation of the new positions of the pixels can be done using trigonometric functions, or by using a suitable UV map with quantized transformations. UV mapping makes use of a mapped texture which can be applied to a 3D model mesh. The projection shape depends on the 3D model mesh used. A 3D engine is used to perform the final rendering on the display in order to obtain the to projection onto a virtual 1D or 2D curved surface.

The distance d to the virtual centre of curvature with respect to the viewer located at point pt may be decreased with increasing FOV.

The field of view and/or projection shape of the visual data for display may be dynamically adjustable based on metadata associated with the visual data, an analysis of the visual data, and/or an input from a user. The FOV adjustment may be gradual to be unnoticeable for the user and start in advance to be aligned before the required level must be met.

If a video has been compressed, the compression method and compression level may affect the final observed resolution. The content may appear pixelated if a high level of compression has been applied to the video, or if a sub-optimal codec has been used. Such lossy compression methods may result in the displayed visual data having contours, blockiness, block boundary discontinuities, or other types of artefacts. The source content may have been encoded with a bitrate below a given threshold (which may depend on the codec used, for example), which may produce spatial compression artefacts. In such circumstances, the VR media player 10 may be configured to reduce the field of view of the visual data for display in the virtual space, which may reduce the visibility of such artefacts.

If the video being viewed on the VR display apparatus is a stereoscopic video, the VR media player 10 may be configured to determine the field of view of the visual data to be displayed and/or the projection shape of the visual data according to a predetermined threshold for an accommodation convergence mismatch of the visual data to be displayed. For example, the VR media player 10 may be configured to determine a maximum FOV for the visual data to be displayed in the virtual space. This corresponds to a maximum magnification of the visual data. Setting a maximum FOV limits the disparities when viewing stereo content through the VR display. The maximum FOV can be determined to be different when viewing video in stereo to when viewing monoscopic video. Accommodation convergence mismatch may occur when the user's eyes focus at the distance at which the light is emitted from the screen, but the user's eyes must verge at another distance (where virtual objects appear to be located in space). By limiting the FOV based the number of disparities in accommodation and convergence, eye strain experienced by the user due to accommodation mismatch may be reduced.

For example, the FOV can be set based on a maximum disparity of stereo content. In one example, the background disparity of 1080p content may be +20 pixels, and the foreground disparity may be −15 pixels. The maximum FOV may be set so that the maximum disparity of 20 pixels can at maximum span over one degree of visual angle. In this case, the horizontal FOV may be set to 96 degrees, based on the horizontal pixel number of 1920 for 1080p content divided by the maximum disparity of 20 pixels.

The VR media player 10 may be configured to determine a suitable FOV, resolution, and/or projection shape based on video data which may include, but which is not limited to: motion tracking data, focal length, and zoom level. This information may be provided in the metadata of the content as captured. Alternatively, the VR media player 10 may analyse the video content. For example, motion vectors may be extracted from encoded video and the motion vectors used to determine a speed of movement of image content. Alternatively, the analysis could involve using optical flow based content analysis. Decreasing a FOV of visual data when viewing motion video may help to reduce any induced motion sickness experienced by a user.

In one example, content originated motion on the display is set to be limited to 5 degrees/second, and the FOV is set to cover 150 degrees. If a rotation motion faster than 2.5 degrees/second is taking place in the content using a camera captured having a 75 degree FOV, the FOV of the content on the display will be reduced. This may help to reduce the amount of induced motion sickness.

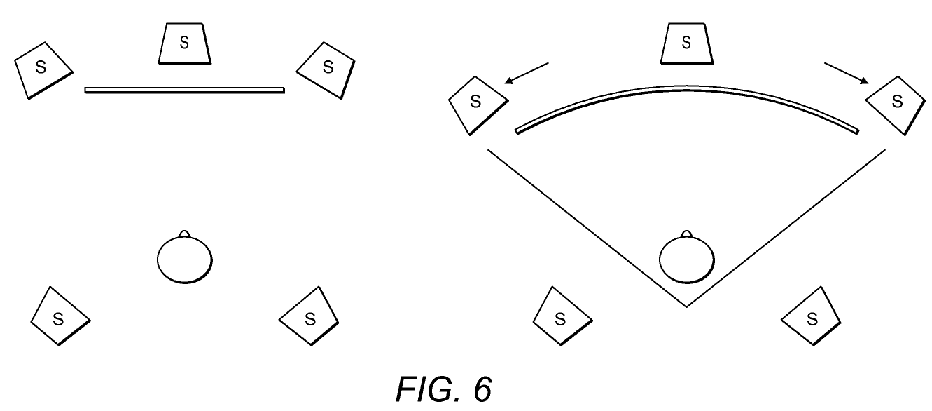

FIG. 6 is a schematic illustration of a spatial audio being linked with the spatial projection of the visual data. The visual data transmitted from the VR media player 10 to the VR headset 20 may be associated with corresponding audio data. The audio data may be spatial audio data. The VR media player 10 may be configured to adjust at least one spatial audio parameter of the spatial audio data. For example, the VR media player 10 may be configured to adjust at least one of a location of at least one audio source, a width or a height of the spatial audio scene, or a combination thereof, such that the spatial audio data corresponds to the spatial projection of the visual data. For example, spatial audio data may be stretched in correspondence with magnified visual data. As illustrated in FIG. 5, the VR media player 10 is configured to provide spatial audio which is stretched and curved in correspondence with the FOV of the displayed visual data and its spatial projection.

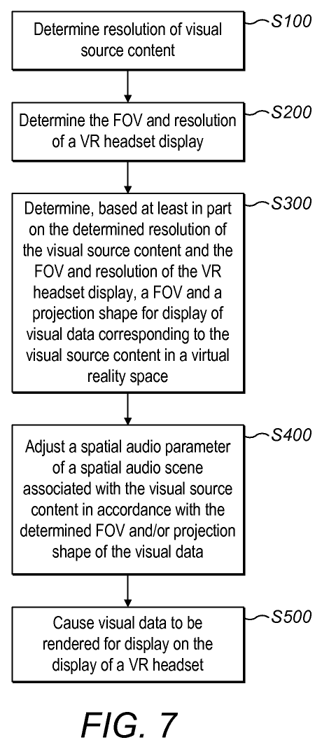

FIG. 7 is a flow chat illustrating various operations performed by the VR media player 10. In some embodiments not all of the illustrated operations need to be performed Operations may be also performed in a different order compared to the order presented in FIG. 7.

In operation S100, the VR media player 10 determines the resolution of visual source content to be displayed in a VR space. The resolution may be determined using the content metadata of the visual source content. Alternatively, the resolution of the visual source content may be determined by analysis of the visual source content, for example, by determining the number of content pixels in the visual source content. The resolution may be determined in any suitable way.

In operation S200, the VR media player 10 determines the FOV and resolution of a VR headset 20 through which the visual data corresponding to the visual source content is to be displayed. The VR media player 10 may receive information relating to the FOV and resolution of the VR headset 20 by communicating with the VR headset 20. Alternatively, the VR media player 10 may store details of the FOV and resolution of the VR headset 20 in a memory. The source content may be any of a two-dimensional video, a two dimensional image, or at least part of a 360 degree panoramic video.

In S300, the VR media player 10 determines, based at least in part on the resolution of the visual data and the FOV and resolution of the VR headset 20, a field of view of the visual data for display in the VR space, and a projection shape for display of the visual data in the VR space. The projection shape may comprise one of a flat projection, a horizontally curved projection, a vertically curved projection, a spherical projection, and a combination thereof.

The FOV and/or projection shape for display of the visual data may be determined based at least in part on a compression level of the visual source content. For example, the VR media player 10 may be configured to reduce a FOV for display of the visual data in order to reduce the visibility of artefacts. Such artefacts may be caused due to a high level of compression having been applied to the source content, or a sub-optimal codec having been used, or the source content may have been encoded with a low bitrate below a given threshold.

The FOV and/or projection shape for display of the visual data may be determined based at least in part on a predetermined threshold for an accommodation convergence mismatch of the visual data.

The FOV and/or projection shape for display of the visual data may be dynamically adjustable based on metadata associated with the visual source content, an analysis of the visual data, and/or an input from a user.

In step S400, the VR media player may be configured to adjust at least one spatial audio parameter of a spatial audio scene associated with the visual source content in accordance with the determined FOV and/or projection shape for display of the visual data. For example, the spatial audio parameter may comprise at least one location of at least one audio source, a width or a height of the spatial audio scene, or a combination thereof. The at least one audio parameter may be also configured to be adjusted based on an input from a user.

In step S500, the VR media player 10 may be configured to cause the visual data to be rendered for display on the display of a VR headset.

For example, the visual data may be rendered using a 3D engine in order to obtain a projection of the visual data onto a surface curved in one or two dimensions.

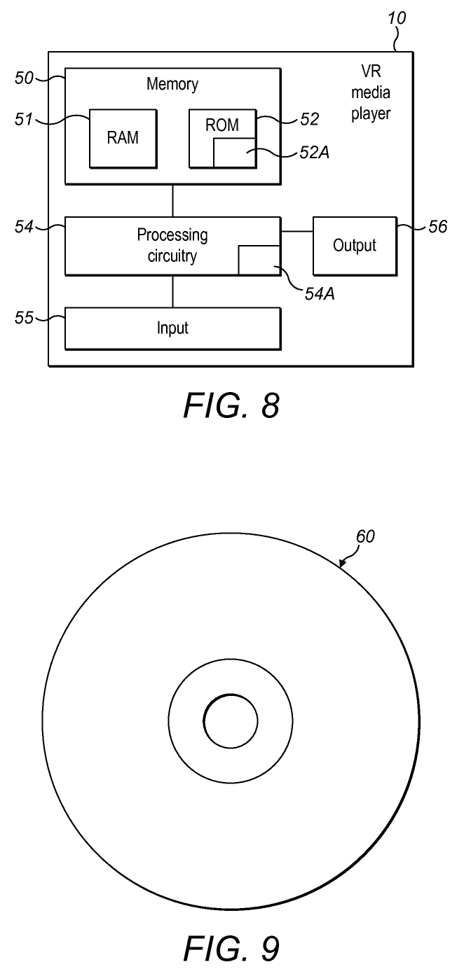

FIG. 8 is a schematic block diagram of an example configuration of a VR media player 10 such as described with reference to FIGS. 1 to 7. The VR media player 10 may comprise memory and processing circuitry. The memory 50 may comprise any combination of different types of memory. In the example of FIG. 8, the memory comprises one or more read-only memory (ROM) media 52 and one or more random access memory (RAM) memory media 51. The VR media player 10 may further comprise one or more input interface 55 which may be configured to receive video content. The processing circuitry 54 may be configured to process the visual data and to determine a FOV of the visual of the visual data for a display in a VR space and to determine a projection shape for display of the visual data in the virtual space. The VR media player 10 may further comprise an output interface 56 configured for transmitting visual data to the VR headset 20.

Although not shown in FIG. 8, the VR media player 10 may in some examples form part of a VR headset 20. For example, as described above, the display of a VR headset 20 may comprise a mobile phone device which converts the visual source content to visual data for display on the screen of the mobile phone device, which is viewable through the lenses of the VR headset 20. In such an example, the mobile phone device also comprises the VR media player 10.

The memory 50 described with reference to FIG. 8 may have computer readable instructions stored thereon 52A, which when executed by the processing circuitry 54 causes the processing circuitry 54 to cause performance of various ones of the operations described above. The processing circuitry 54 described above with reference to FIG. 8 may be of any suitable composition and may include one or more processors 54A of any suitable type or suitable combination of types. For example, the processing circuitry 54 may be a programmable processor that interprets computer program instructions and processes data. The processing circuitry 54 may include plural programmable processors. Alternatively, the processing circuitry 54 may be, for example, programmable hardware with embedded firmware. The processing circuitry 54 may be termed processing means. The processing circuitry 54 may alternatively or additionally include one or more Application Specific Integrated Circuits (ASICs). In some instances, processing circuitry 54 may be referred to as computing apparatus.

The processing circuitry 54 described with reference to FIG. 8 is coupled to the memory 50 (or one or more storage devices) and is operable to read/write data to/from the memory. The memory may comprise a single memory unit or a plurality of memory units 52 upon which the computer readable instructions 52A (or code) is stored. For example, the memory 30 may comprise both volatile memory 51 and non-volatile memory 52. For example, the computer readable instructions 52A may be stored in the non-volatile memory 52 and may be executed by the processing circuitry 54 using the volatile memory 51 for temporary storage of data or data and instructions. Examples of volatile memory include RAM, DRAM, and SDRAM etc. Examples of non-volatile memory include ROM, PROM, EEPROM, flash memory, optical storage, magnetic storage, etc. The memories 50 in general may be referred to as non-transitory computer readable memory media.

The term ‘memory’, in addition to covering memory comprising both non-volatile to memory and volatile memory, may also cover one or more volatile memories only, one or more non-volatile memories only, or one or more volatile memories and one or more non-volatile memories.

The computer readable instructions 52A described herein with reference to FIG. 8 may be pre-programmed into the VR media player 10. Alternatively, the computer readable instructions 52A may arrive at the VR media player 10 via an electromagnetic carrier signal or may be copied from a physical entity such as a computer program product, a memory device or a record medium such as a CD-ROM or DVD. The computer readable instructions 52A may provide the logic and routines that enable the VR media player 10 to perform the functionalities described above. The combination of computer-readable instructions stored on memory (of any of the types described above) may be referred to as a computer program product.

FIG. 9 illustrates an example of a computer-readable medium 60 with computer-readable instructions (code) stored thereon. The computer-readable instructions (code), when executed by a processor, may cause any one of or any combination of the operations described above to be performed.

Where applicable, wireless communication capability of the VR media player 10 may be provided by a single integrated circuit. It may alternatively be provided by a set of integrated circuits (i.e. a chipset). The wireless communication capability may alternatively be provided by a hardwired, application-specific integrated circuit (ASIC). Communication between the devices comprising the VR display system may be provided using any suitable protocol, including but not limited to a Bluetooth protocol (for instance, in accordance or backwards compatible with Bluetooth Core Specification Version 4.2) or a IEEE 802.11 protocol such as Wi-Fi.

As will be appreciated, the VR media player 10 described herein may include various hardware components which have may not been shown in the Figures since they may not have direct interaction with embodiments of the invention.

Embodiments of the present invention may be implemented in software, hardware, application logic or a combination of software, hardware and application logic. The software, application logic and/or hardware may reside on memory, or any computer media. In an example embodiment, the application logic, software or an instruction set is maintained on any one of various conventional computer-readable media. In the context of this document, a “memory” or “computer-readable medium” may be any non-transitory media or means that can contain, store, communicate, propagate or transport the instructions for use by or in connection with an instruction execution system, apparatus, or device, such as a computer.

Reference to, where relevant, “computer-readable storage medium”, “computer program product”, “tangibly embodied computer program” etc., or a “processor” or “processing circuitry” etc. should be understood to encompass not only computers having differing architectures such as single/multi-processor architectures and sequencers/parallel architectures, but also specialised circuits such as field programmable gate arrays FPGA, application specific circuits ASIC, signal processing devices and other devices. References to computer program, instructions, code etc. should be understood to express software for a programmable processor firmware such as the programmable content of a hardware device as instructions for a processor or configured or configuration settings for a fixed function device, gate array, programmable logic device, etc.

As used in this application, the term ‘circuitry’ refers to all of the following: (a) hardware-only circuit implementations (such as implementations in only analogue and/or digital circuitry) and (b) to combinations of circuits and software (and/or firmware), such as (as applicable): (i) to a combination of processor(s) or (ii) to portions of processor(s)/software (including digital signal processor(s)), software, and memory(ies) that work together to cause an apparatus, such as a mobile phone or server, to perform various functions) and (c) to circuits, such as a microprocessor(s) or a portion of a microprocessor(s), that require software or firmware for operation, even if the software or firmware is not physically present.

This definition of ‘circuitry’ applies to all uses of this term in this application, including in any claims. As a further example, as used in this application, the term “circuitry” would also cover an implementation of merely a processor (or multiple processors) or portion of a processor and its (or their) accompanying software and/or firmware. The term “circuitry” would also cover, for example and if applicable to the particular claim element, a baseband integrated circuit or applications processor integrated circuit for a mobile phone or a similar integrated circuit in server, a cellular network device, or other network device.

If desired, the different functions discussed herein may be performed in a different order and/or concurrently with each other. Furthermore, if desired, one or more of the above-described functions may be optional or may be combined. Similarly, it will also be appreciated that the flow diagram of FIG. 7 is an example only and that various operations depicted therein may be omitted, reordered and/or combined.

Although various aspects of the invention are set out in the independent claims, other aspects of the invention comprise other combinations of features from the described embodiments and/or the dependent claims with the features of the independent claims, and not solely the combinations explicitly set out in the claims.

As used herein, visual data may be a framed video or a still image. The visual data may be in 2D, stereo, or 3D.

It is also noted herein that while the above describes various examples, these descriptions should not be viewed in a limiting sense. Rather, there are several variations and modifications which may be made without departing from the scope of the appended claims.

1. A method comprising:
determining a resolution of visual source content;
determining a resolution and a field of view of a display of a virtual reality headset;
determining, based at least in part on the resolution of the visual source content, the resolution of the display, and the field of view of the display: a field of view for display of visual data corresponding to the visual source content in the virtual reality space; and a projection shape for display of the visual data corresponding to the visual source content in the virtual reality space, the projection shape comprising one of a flat projection, a horizontally curved projection, a vertically curved projection, a spherical projection, and a combination thereof.

2. A method according to claim 1, wherein the field of view and/or projection shape for display of the visual data is determined based at least in part on a compression level of the visual source content.

3. The method according to claim 1, wherein the field of view and/or projection shape for display of the visual data is determined based on a predetermined threshold for an accommodation convergence mismatch of the visual data.

4. The method according to claim 1, further comprising adjusting at least one spatial audio parameter of a spatial audio scene associated with the visual data in accordance with the field of view and/ or the projection shape for display of the visual data.

5. The method according to claim 4 wherein the spatial audio parameter comprises at least one location of at least one audio source, a width or a height of the spatial audio scene, or a combination thereof.

6. The method according to claim 1, wherein the visual source content comprises at least one two-dimensional video, at least one two-dimensional image, or at least part of a 360 degree panoramic video.

7. The method according to claim 1, wherein at least one of the field of view and the projection shape for display of the visual data is dynamically adjustable based on metadata associated with the visual source content, an analysis of the visual data, and/or an input from a user.

8. A method according to claim 7, wherein the field of view and/or the projection shape for display of the visual data is dynamically adjustable based at least in part on visual source content data comprising at least one of motion tracking data, focal length, and zoom level.

9. (canceled)

10. A computer program comprising machine readable instructions that when executed by computing apparatus causes it to perform the method of claim 1.

11. Apparatus configured to perform the method of claim 1.

12. Apparatus comprising:
at least one processor; and
at least one memory including computer program code, which when executed by the at least one processor, causes the apparatus to perform a method comprising:
determining a resolution of visual source content;
determining a resolution and a field of view of a display of a virtual reality headset;
determining, based at least in part on the resolution of the visual source content, the resolution of the display, and the field of view of the display: a field of view for display of visual data corresponding to the visual source content in the virtual reality space; and a projection shape for display of the visual data corresponding to the visual source content in the virtual reality space, the projection shape comprising one of a flat projection, a horizontally curved projection, a vertically curved projection, a spherical projection, and a combination thereof.

13. Apparatus according to claim 12, wherein the field of view and/or projection shape for display of the visual data is determined based at least in part on a compression level of the visual source content.

14. Apparatus according to claim 12, wherein the field of view and/or projection shape for display of the visual data is determined based on a predetermined threshold for an accommodation convergence mismatch of the visual data.

15. Apparatus according to claim 12, wherein the computer program code, when executed by the at least one processor, causes the apparatus to perform:
adjusting at least one spatial audio parameter of a spatial audio scene associated with the visual data in accordance with the field of view and/or the projection shape for display of the visual data.

16. Apparatus according to claim 15, wherein the spatial audio parameter comprises at least one location of at least one audio source, a width or a height of the spatial audio scene, or a combination thereof.

17. Apparatus according to claim 12, wherein the visual source content comprises at least one two-dimensional video, at least one two-dimensional image, or at least part of a 360 degree panoramic video.

18. Apparatus according to claim 12, wherein at least one of the field of view and the projection shape for display of the visual data is dynamically adjustable based on metadata associated with the visual source content, an analysis of the visual data, and/or an input from a user.

19. Apparatus according to claim 18, wherein the field of view and/or the projection shape for display of the visual data is dynamically adjustable based at least in part on visual source content data comprising at least one of motion tracking data, focal length, and zoom level.

20. (canceled)

21. A computer-readable medium having computer-readable code stored thereon, the computer-readable code, when executed by at least one processor, cause performance of at least:
determining a resolution of visual source content;
determining a resolution and a field of view of a display of a virtual reality headset;
determining, based at least in part on the resolution of the visual source content, the resolution of the display, and the field of view of the display: a field of view for display of visual data corresponding to the visual source content in the virtual reality space; and a projection shape for display of the visual data corresponding to the visual source content in the virtual reality space, the projection shape comprising one of a flat projection, a horizontally curved projection, a vertically curved projection, a spherical projection, and a combination thereof.

22. Apparatus comprising means for:
determining a resolution of visual source content;
determining a resolution and a field of view of a display of a virtual reality headset;
determining, based at least in part on the resolution of the visual source content, the resolution of the display, and the field of view of the display: a field of view for display of visual data corresponding to the visual source content in the virtual reality space; and a projection shape for display of the visual data corresponding to the visual source content in the virtual reality space, the projection shape comprising one of a flat projection, a horizontally curved projection, a vertically curved projection, a spherical projection, and a combination thereof.
